(19) United States
(12) Patent Application Publication
(10) Pub. No.: US 2012/0218674 A1
(43) Pub. Date: Aug. 30, 2012

(54) Overcurrent Protection System

(76) Inventors: Neal H. Schultz, Sunnyvale, CA (US); Sirikhit Maniraj, East Palo Alto, CA (US); Matthew R. Williams, Pleasanton, CA (US)

(21) Appl. No.: 13/037,189

(22) Filed: Feb. 28, 2011

(51) Int. Cl. H02H 5/04

(52) U.S. Cl. 361/93.8

(57) ABSTRACT

An overcurrent protection system may be used to protect electrical circuit components from damage or failure due to abnormally high currents. The system may include a current interrupter electrically coupled between a power source and an electrical load. The current interrupter is configured to interrupt at least a portion of a current flow between the power source and the electrical load based on at least one current interrupt characteristic of the current interrupter. The system may also include an analog circuit component thermally coupled with the current interrupter. The analog circuit component is configured to generate heat in response to an overcurrent fault condition. At least a portion of the heat modifies the at least one current interrupt characteristic of the current interrupter.

### BACKGROUND

1. Technical Field

This application relates to overcurrent protection systems and, more particularly, to thermal control of current interrupters.

2. Related Art

An overcurrent is an abnormally high current that may have the potential to cause failure in an electrical circuit. For example, a short circuit, an excessive electrical load, an over-lamping configuration, an out-of-range condition in a power source, or a decrease in load impedance may cause an overcurrent to flow through a circuit. Overcurrent protection systems attempt to shield electrical circuit components from the potentially harmful effects associated with overcurrents.

Some overcurrent protection systems include a fuse, a circuit breaker, or another type of current interrupter device to interrupt at least a portion of the current flow in the circuit upon detection of an overcurrent event. One example of a current interrupter is a positive temperature coefficient (“PTC”) device that may help protect circuit components from overcurrent damage by going from a low-resistance state to a high resistance state in response to the increased current that flows through the device during an overcurrent event.

A circuit designer may consider a large number of variables when selecting the appropriate type of current interrupter for an application. For example, the circuit designer may analyze the expected ambient operating temperature, the expected operating current, the expected operating voltage, the desired current interrupt point, and other factors before selecting an appropriate current interrupter device for the application. Component manufacturers offer a large variety of current interrupters that may be suitable for certain applications without modification. However, other applications may require a customized solution that tailors the current interrupt characteristics of the current interrupter device to the specific application. Therefore, a need exists for improved control of the current interrupt characteristics of overcurrent protection devices.

### SUMMARY

An overcurrent protection system may be used to protect electrical circuit components from damage or failure due to abnormally high currents. In one implementation, the system includes a current interrupter electrically coupled between a power source and an electrical load. The current interrupter is configured to interrupt at least a portion of a current flow between the power source and the electrical load based on at least one current interrupt characteristic of the current interrupter. The system may also include an analog circuit component thermally coupled with the current interrupter. The analog circuit component is configured to generate heat in response to an overcurrent fault condition. At least a portion of the heat modifies the at least one current interrupt characteristic of the current interrupter.

In another implementation, the system includes a current interrupter and a non-linear analog circuit component. The current interrupter is electrically coupled between a power source and an electrical load. The non-linear analog circuit component is electrically and thermally coupled with the current interrupter. The current interrupter comprises a predetermined trip current threshold. The non-linear analog circuit component is configured to emit heat to the current interrupter in response to an overcurrent fault condition and cause the current interrupter to interrupt at least a portion of a current flow between the power source and the electrical load at a current level that is below the predetermined trip current threshold.

In yet another implementation, the system includes a polymeric positive temperature coefficient device electrically coupled between a power source and an electrical load. The polymeric positive temperature coefficient device is configured to interrupt at least a portion of a current flow between the power source and the electrical load based on at least one current interrupt characteristic of the polymeric positive temperature coefficient device. The system may also include an analog circuit electrically coupled with the polymeric positive temperature coefficient device. The analog circuit comprises a resistor electrically coupled in parallel with a diode. The diode is thermally coupled with the polymeric positive temperature coefficient device and is configured to generate heat in response to an overcurrent fault condition. At least a portion of the heat modifies the current interrupt characteristic of the polymeric positive temperature coefficient device.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

FIG. 1 illustrates an example of an overcurrent protection system.

FIG. 2 is an electrical schematic diagram that includes a current interrupter and an analog thermal control circuit.

FIG. 3 is a mechanical diagram that includes a current interrupter and an analog thermal control circuit.

FIGS. 4-15 illustrate alternative mechanical diagrams that include one or more current interrupters and one or more analog circuit components of an analog thermal control circuit.

FIG. 16 is an alternative electrical schematic diagram that includes a current interrupter and an analog thermal control circuit.

### DETAILED DESCRIPTION OF THE INVENTION

An overcurrent protection system may be used to protect electrical circuit components from damage or failure due to abnormally high currents. The system may include a current interrupter electrically coupled between a power source and an electrical load. The current interrupter is configured to interrupt at least a portion of a current flow between the power source and the electrical load in response to an overcurrent fault condition. The system may also include a non-linear analog circuit component electrically coupled with the current interrupter. The non-linear analog circuit component is thermally coupled with the current interrupter in a configuration that provides an external source of heat to the current interrupter in response to the overcurrent fault condition.

The heat generated and emitted from the non-linear analog circuit component during an overcurrent fault condition may be used to alter the standard operating characteristics of the current interrupter. As one example, the current interrupter may be initially designed or rated to interrupt current flow when the current passing through the device reaches a predetermined trip current level. As another example, the current interrupter may be initially designed or rated to interrupt current flow within a predetermined amount of time from onset of the overcurrent fault condition. In some applications, it may be desirable to interrupt the current flow faster than the predetermined or standard amount of time or in response to an amount of current that is lower than the predetermined or standard trip current level. In these applications, the current interruption characteristics of the current interrupter may be customized by using external heat generated and emitted from a non-linear analog circuit component of the overcurrent protection system.

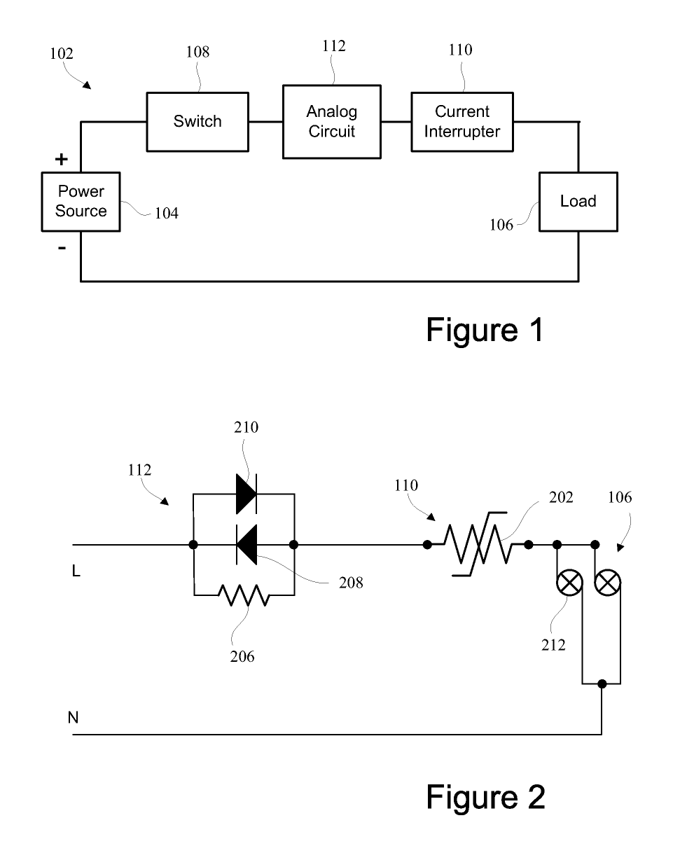

FIG. 1 illustrates one implementation of an overcurrent protection system 102. The system 102 includes a power source 104, an electrical load 106, and a switch 108. The power source 104 generates a source voltage and an operating current to power the electrical load 106. The power source 104 may be an alternating current (“AC”) power source or a direct current (“DC”) power source, and the electrical load 106 may be a lamp, light bulb, fan, motor, loudspeaker, computer component, or any other device driven by a power source. The switch 108 controls the current flow between the power source 104 and the electrical load 106. When the switch 108 is placed in a closed configuration, the electrical load 106 is electrically coupled with the power source 104 and therefore may be considered to be in an “on” state. When the switch 108 is placed in an open configuration, the electrical load 106 is electrically isolated from the power source 104 and therefore may be considered to be in an “off” state. The switch 108 may be any electrical component that can break an electrical circuit, interrupt the current in the circuit, or divert current to a different part of the circuit, such as a light switch, wall switch, fan pull switch, remote controlled electrical switch, or any other electrical switch for controlling the current flow between the power source 104 and the electrical load 106. In some implementations, the system may connect the electrical load 106 with the power source 104 without the switch 108 to keep the electrical load 106 in a continuous “on” state during normal operation.

The system 102 of FIG. 1 also includes a current interrupter 110 coupled between the power source 104 and the electrical load 106. As shown in FIG. 1, the current interrupter 110 is situated closer to the electrical load 106 than to the power source 104. In another implementation, the current interrupter 110 is situated closer to the power source 104 than to the electrical load 106. When a power source and electrical load are connected in an electrical circuit, a standard current level condition or an overcurrent fault condition may occur. During a standard current level condition, the current flow in the system is within an acceptable range for the application and the level of current is unlikely to cause damage or failure of the circuit components. In an overcurrent fault condition, there may be a problem somewhere in the system that may cause a much higher current flow. During a standard operating condition period, the current interrupter 110 may allow all or a majority of the current to continue to flow through the circuit. In response to an overcurrent fault condition, the current interrupter 110 may interrupt all or at least a portion of a current flow between the power source 104 and the electrical load 106.

In one implementation, the current interrupter 110 is configured to completely block current from flowing during an overcurrent fault condition period. In another implementation, the current interrupter 110 serves as a current limiter that prevents dangerous current levels from flowing through the circuit, but still allows a smaller portion of the current to pass after an overcurrent fault condition of sufficient duration. The current interrupter 110 may be a fuse, positive temperature coefficient (“PTC”) device that may be a polymeric PTC device or a ceramic PTC device, bimetallic breaker, or any other device that may interrupt (e.g., limit or block) current flow at different points based on device temperature.

The system 102 of FIG. 1 also includes an analog circuit 112 coupled with the current interrupter 110 between the power source 104 and the electrical load 106. The analog circuit 112 serves as an analog thermal control tuning circuit for the current interrupter 110 in order for the analog circuit 112 to alter one or more aspects of the current interrupter 110. For example, the analog circuit 112 includes one or more components that may alter the standard current interrupt characteristics of the current interrupter 110 by generating and applying an external source of heat to the current interrupter 110 during an overcurrent fault condition. In another implementation, the analog circuit may alter other aspects of the current interrupter 110. The analog circuit 112 may use thermal convection, thermal radiation, thermal conduction, or another heat transfer mode to increase a temperature of the current interrupter 110 during an overcurrent fault condition.

In one implementation, the analog circuit 112 may include a non-linear analog circuit component electrically and thermally coupled with the current interrupter 110. The non-linear analog circuit component may be a diode, transistor, varistor (e.g., a metal oxide varistor (“MOV”)), or other device with a non-linear current-voltage characteristic (“I-V characteristic”). The incremental change in current that flows through a non-linear device in response to an incremental change in voltage across the device depends on the location of the applied voltage level on the I-V curve of the device. For example, a change from 0.2 volts to 0.3 volts across a silicon diode may not result in much if any increase in current flow. However, an increase from 0.7 to 0.8 volts may result in a relatively large increase in current flow.

The non-linear analog circuit component may generate substantial heat in some situations and generate little or no heat in other situations. For example, the amount of heat generated and emitted from the non-linear analog circuit component may be based on the amount of current flowing through the non-linear analog circuit component. The non-linear analog circuit component may conduct little or no current (and thus generate little or no heat) when the voltage applied across the component is below a predetermined voltage threshold (e.g., about 0.7 volts for silicon diodes, about 0.3 volts for Schottky diodes, about 0.2 volts for Germanium diodes, or higher voltage levels for Zener diodes and MOVs). Once the voltage applied across the component exceeds the predetermined voltage threshold necessary to place the device into a forward bias state, the amount of current passing through the device increases at a much greater rate as voltage increases. As the amount of current that passes through the non-linear analog circuit component increases, the heat generated by the component also increases.

The non-linear analog circuit component of the analog circuit 112 of FIG. 1 may be thermally coupled with the current interrupter 110 in a configuration that provides an external source of heat to the current interrupter 110 in response to an overcurrent fault condition. The analog circuit 112 may include supporting analog circuit components that are selected to ensure that the amount of voltage applied across the non-linear analog circuit component is below the predetermined voltage threshold in a standard operating current range, and above the predetermined voltage threshold in an overcurrent fault condition where the current flow in the circuit exceeds a predetermined threshold. In such a situation, the analog circuit 112 ensures that the non-linear analog circuit component generates little or no heat during a standard operating condition period, but generates a relatively large amount of heat during the overcurrent fault condition. FIG. 2 illustrates one implementation of the use of analog circuit components to control the amount of voltage applied across the non-linear analog circuit component, as will be discussed in more detail below.

The current interrupter 110 of FIG. 1 may be designed or rated to have a predetermined trip current threshold. When the current flow through the current interrupter 110 exceeds the predetermined trip current threshold, the current interrupter 110 interrupts at least a portion of the current flow. The current interrupter 110 may interrupt current flow faster or at a lower current level when an external source of heat is applied to the current interrupter 110. In implementations where the non-linear analog circuit component of the analog circuit 112 is thermally coupled with the current interrupter 110, the heat generated and emitted from the non-linear analog circuit component during an overcurrent fault condition may cause the current interrupter 110 to interrupt at least a portion of the current flow faster or at a current level that is below the predetermined trip current threshold of the current interrupter 110.

A thermal coupling medium may couple the non-linear analog circuit component of the analog circuit 112 and the current interrupter 110. For example, the thermal coupling medium may be positioned between the non-linear analog circuit component of the analog circuit 112 and the current interrupter 110. The thermal coupling medium is configured to transfer at least a part of the heat generated from the non-linear analog circuit component to the current interrupter 110. In one implementation, the thermal coupling medium may be air, such as illustrated in FIG. 4. In another implementation, the thermal coupling medium may be a material that physically connects the non-linear analog circuit component to the current interrupter 110, such as illustrated in FIG. 5.

In one implementation, a heat-emitting surface of the non-linear analog circuit component of the analog circuit 112 is thermally coupled with the current interrupter 110 by being located about 3 millimeters or less from a heat-receiving surface of the current interrupter 110. In another implementation, a heat-emitting surface of the non-linear analog circuit component is thermally coupled with the current interrupter 110 by being located about 5 millimeters or less from a heat-receiving surface of the current interrupter 110. In yet another implementation, a heat-emitting surface of the non-linear analog circuit component is thermally coupled with the current interrupter 110 by being located about 1 millimeter or less from a heat-receiving surface of the current interrupter 110. Other distances between the heat-emitting surface of the non-linear analog circuit component and the heat-receiving surface of the current interrupter 110 may be sufficient for heat transfer depending on the characteristics of the intended application. A relative placement of the components, or a distance limit to the separation of the components, may be determined based on the amount of heat generated by the non-linear analog circuit component in the overcurrent fault condition, the medium between the components, the desired change in the standard current interrupt characteristics of the current interrupter 110, and other factors. Therefore, the current interrupt characteristics of the current interrupter 110 may be customized to various applications by altering these and other variables. For example, when the non-linear analog circuit component generates and emits heat that is applied to the current interrupter 110, the current interrupter 110 may interrupt current flow at a different point than if the non-linear analog circuit component was absent or positioned further away from the current interrupter 110.

FIG. 2 is an electrical schematic diagram of one implementation of a current interrupter 110 and an analog circuit 112. The current interrupter 110 of FIG. 2 comprises a polymeric PTC device 202. The PTC device 202 may help protect one or more other circuit components from abnormally high current flow during an overcurrent fault condition. The PTC device 202 may reset after the fault is cleared. Therefore, the PTC device 202 of FIG. 2 provides an interruptible and resettable current path between a power source and the electrical load 106 (e.g., a light bulb 212).

The PTC device 202 may be a polymeric PTC device made from a composite of semi-crystalline polymer and conductive particles. At normal temperature, the conductive particles form low-resistance networks in the polymer. However, if the temperature rises above the device's switching temperature either from high current flow through the PTC device 202 or from an increase in the ambient temperature, the crystallites in the polymer melt and become amorphous. The increase in volume during melting of the crystalline phase separates the conductive particles resulting in a large non-linear increase in the resistance of the PTC device 202.

The PTC device 202 of FIG. 2 is connected in series with the load 106. The PTC device 202 protects the load 106 and other components in the circuit by going from a low-resistance state to a high-resistance state in response to an overcurrent fault condition. This is referred to as “tripping” the device. In normal operation, the PTC device 202 may have a resistance that is much lower than the remainder of the circuit. In response to an overcurrent condition, the PTC device 202 increases in resistance, thereby reducing the current in the circuit to a value that may be safely carried by the other circuit elements. The increase in resistance of the device is the result of an increase in the temperature of the device (e.g., I²R heating).

The operation of the PTC device 202 is based on an overall energy balance. Under normal operating conditions, the heat generated by the device and the heat lost by the device to the environment may be in balance at a relatively low temperature. If the current through the PTC device 202 is increased while the ambient temperature is kept constant, the temperature of the device increases. Further increases in either current, ambient temperature or both may cause the device to reach a temperature where the resistance rapidly increases.

Any further increase in current or ambient temperature may cause the device to generate heat at a rate greater than the rate at which heat can be dissipated, thus causing the device to heat up rapidly. At this stage, a very large increase in resistance occurs for a very small change in temperature. This is the normal operating region for a PTC device in the tripped state. This large change in resistance causes a corresponding decrease in the current flowing in the circuit. As long as the power dissipated in the PTC device maintains the melt temperature, the device will maintain a high impedance. By removing power and allowing the device a sufficient time to cool the PTC device may be “reset.”

In one implementation, the PTC device 202 may be a 1 amp hold current, 120 volt PTC device (e.g., a PolySwitch™ LVRL100 device sold by Tyco Electronics Corporation). In another implementation, the PTC device 202 may be a 0.75 amp hold current, 120 volt PTC device (e.g., a PolySwitch™ LVRL075 device sold by Tyco Electronics Corporation). Other implementations may use different current interrupters rated for different hold or trip current levels. The specific type of PTC device used may be application specific. For example, some applications may use a PTC device that is rated to trip at a 2.0 amp current level and other applications may use a PTC device that is rated to trip at a 1.0 amp current level. The heat generated by the analog circuit 112 and applied to the PTC device 202 may then be used to adjust the standard trip current level of the selected PTC device. As one example, the heat generated by the analog circuit 112 may cause a PTC device rated to trip at a 2.0 amp current level to trip at a 1.7 amp current level.

An overcurrent protection system may include one PTC device or multiple PTC devices. Moreover, the multiple PTC devices may be placed in a variety of configurations, such as two PTC devices in parallel or more than two PTC devices in parallel. As one example, one or more additional PTC devices could be connected in parallel with the PTC device 202 of FIG. 2. In an implementation where multiple PTC devices are connected in parallel, the total current flowing through the circuit may be divided between the multiple PTC devices. The multiple PTC devices may be substantially the same or may be different, such as having the same or different trip current ratings or the same or different hold current ratings.

The analog thermal control circuit 112 of FIG. 2 comprises a resistor 206, a first diode 208, and a second diode 210. The resistor 206 is electrically coupled in a parallel configuration with the diodes 208 and 210. The two diodes 208 and 210 may be positioned with their respective cathodes in different orientations to accommodate AC current flow. The diodes 208 and 210 may be rectifier type diodes. When the AC current is flowing in a direction from left to right in the view of FIG. 2 (and the voltage across the diodes is sufficient to place them into the forward bias state), the diode 210 will pass current and generate heat in response, while the diode 208 may not conduct much heat during this period. When the AC current is flowing in a direction from right to left in the view of FIG. 2 (and the voltage across the diodes is sufficient to place them into the forward bias state), the diode 208 will pass current and generate heat in response, while the diode 210 may not conduct much heat during this period.

FIG. 2 illustrates one implementation of the use of the resistor 206 to control the amount of voltage applied across the diodes 208 and 210. The value of the resistor 206 may be selected in view of the expected current levels of the application to ensure that the diodes 208 and 210 generate little or no heat during a standard operating condition period, but generate a relatively large amount of heat during an overcurrent fault condition. The analog circuit 112 may be designed so that the resistor 206 carries more current than the diodes 208 and 210 during a first period when a current level through the resistor 206 is below a predetermined threshold (e.g., during a normal operation period). When the current level through the resistor 206 is above the predetermined threshold during a second period (e.g., during an overcurrent fault condition period), the diodes 208 and 210 may begin to carry a higher level of current. For example, all of the circuit current or a majority of the circuit current may flow through the resistor 206 (instead of through the diodes 208 and 210), until the voltage drop across the resistor 206 meets or exceeds the threshold voltage level of the diodes 208 and 210. When the voltage drop across the resistor 206 exceeds the threshold voltage level of the diodes 208 and 210, more of any additional excess overcurrent may, in some implementations, flow through the diodes 208 and 210 (instead of through the resistor 206), thereby increasing the amount of heat generated by the diodes 208 and 210. The voltage drop across the resistor 206 is defined by the resistance of the resistor 206 and the current level passing through the resistor 206 according to Ohm's law (V=I×R). The value of the resistor 206 may be selected to be low enough to keep the diodes 208 and 210 in an “off” state in response to the expected current levels during normal operation. The value of the resistor 206 may also be selected to be high enough to place the diodes 208 and 210 in an “on” state in response to the expected current levels during an overcurrent condition. In one implementation, the resistor may be a 0.8 ohm, 2.0 watt resistor, although other resister values may be selected based on the needs of the individual application.

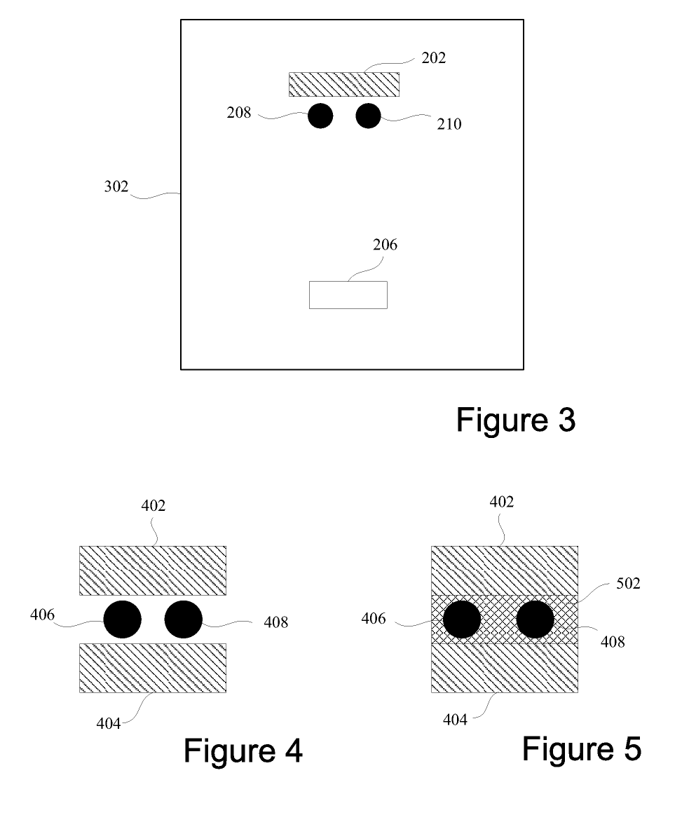

FIG. 3 is one implementation of a mechanical layout on a circuit board 302 of the overcurrent protection circuit of FIG. 2. As shown in FIG. 3, the distance between the heat-emitting portions of the diodes 208 and 210 and the PTC device 202 is smaller than the distance between the heat-emitting portions of the resistor 206 and the PTC device 202. The resistor 206 may generate heat in response to any levels of current flow, while the diodes 208 and 210 may generate substantial heat only in response to relatively large current flow (e.g., current flow sufficient to satisfy the voltage threshold that places a diode in a forward bias state). Therefore, in some implementations the PTC device 202 may operate closer to the predetermined standard hold current characteristics of the PTC device 202 when normal current levels are experienced in the circuit, but may operate with altered interrupt characteristics when overcurrent levels are experienced in the circuit. For example, by selectively heating the PTC device 202 only when excess current occurs, the thermal control by the analog circuit 112 may have a greater impact on the trip current level of the PTC device 202 than on the hold current level of the PTC device 202. Therefore, the inclusion of the analog thermal control circuit 112 to heat the PTC device 202 during an overcurrent fault condition may serve to reduce a trip to hold current ratio of the PTC device 202.

The diodes 208 and 210 may be thermally coupled with the PTC device 202. For example, the diodes 208 and 210 may be located within a distance from the PTC device 202 that allows heat generated by the diodes 208 and 210 to increase the temperature of the PTC device 202. In some implementations, the resistor 206 may be thermally isolated from the PTC device 202. For example, the resistor 206 may be located outside of a thermal range of the PTC device 202 so that heat generated by the resistor 206 does not have a substantial effect on the temperature of the PTC device 202. The heat from the resistor 206 may still have some effect on the PTC device 202 due to increased ambient temperature, but it may have less of an effect on the PTC device 202 than the heat from the diodes 208 and 210 during an overcurrent fault condition.

FIGS. 4-15 illustrate alternative mechanical diagrams that include one or more current interrupters, such as one or more PTC devices, and one or more non-linear analog circuit components, such as one or more diodes. FIG. 4 illustrates an implementation of an overcurrent protection system that includes a first PTC device 402, a second PTC device 404, a first diode 406, and a second diode 408. The diodes 406 and 408 are positioned adjacent to the PTC devices 402 and 404 to localize the transmission of heat energy from the source nonlinear circuit elements (e.g., diodes 406 and 408) to the target thermally responsive current interrupters (e.g., PTC devices 402 and 404). When the diodes 406 and 408 are passing current, the heat generated and emitted by the diodes 406 and 408 in response to an overcurrent fault condition increases a temperature of the PTC devices 402 and 404.

FIG. 5 illustrates an implementation of the overcurrent protection system of FIG. 4 with the addition of a thermal coupling material 502 disposed between the heat-emitting surfaces of the diodes and the heat-receiving surfaces of the PTC devices. The thermal coupling material 502 is configured to transfer heat from the diodes 406 and 408 to the PTC devices 402 and 404. In one implementation, the thermal coupling material 502 may be a thermally conducting epoxy that bonds the diodes 406 and 408 to the PTC devices 402 and 404. The thermally conducting epoxy may be an electrical insulator to prevent undesired current paths between the components.

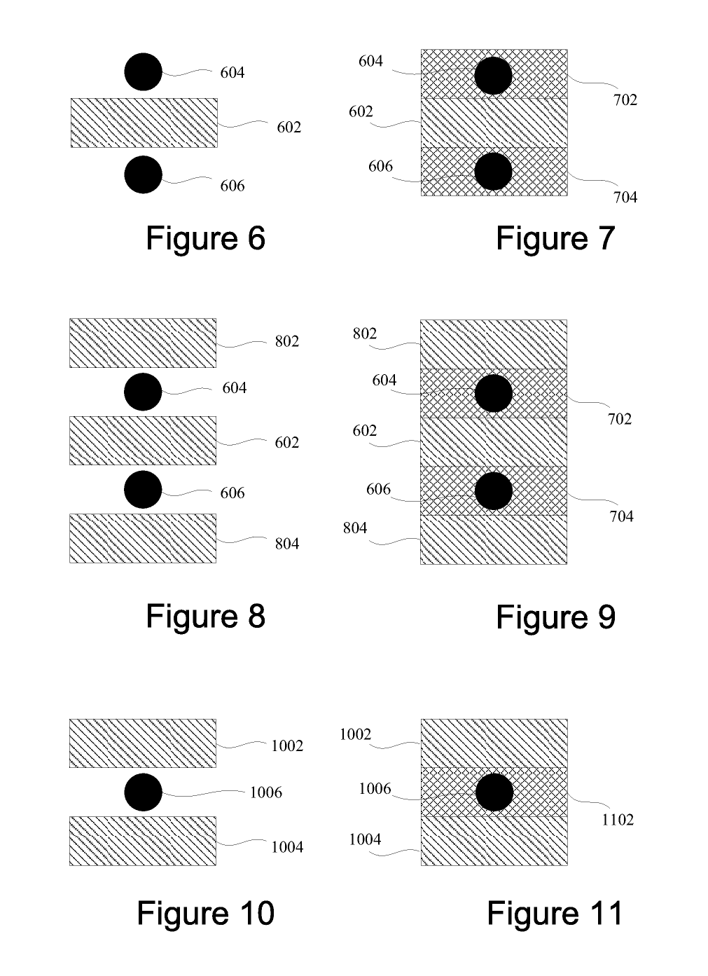

FIG. 6 illustrates an implementation of an overcurrent protection system that includes a single PTC device 602, a first diode 604, and a second diode 606. The first diode 604 is positioned adjacent to the PTC device 602 on a first side of the PTC device 602. The second diode 606 is positioned adjacent to the PTC device 602 on a second side of the PTC device 602. FIG. 7 illustrates an implementation of the overcurrent protection system of FIG. 6 with the addition of a first thermal coupling material 702 and a second thermal coupling material 704. The thermal coupling materials 702 and 704 of FIG. 7 may be similar to the thermal coupling material 502 described in connection with FIG. 5. The first thermal coupling material 702 is disposed between the heat-emitting surface of the diode 604 and a heat-receiving surface on a first side of the PTC device 602. The second thermal coupling material 702 is disposed between the heat-emitting surface of the diode 604 and the heat-receiving surface of the PTC device 602.

FIG. 8 illustrates an implementation of an overcurrent protection system that includes the components of FIG. 6 in addition to a second PTC device 802 and a third PTC device 804. The additional PTC devices 802 and 804 may be electrically connected in parallel with the PTC device 602. In this implementation, the first diode 604 is positioned adjacent to the PTC devices 602 and 802, and the second diode 606 is positioned adjacent to the PTC devices 602 and 804. Similarly, FIG. 9 illustrates an implementation of the overcurrent protection system of FIG. 7 with the addition of the PTC devices 802 and 804.

FIG. 10 illustrates an implementation of an overcurrent protection system that includes a first PTC device 1002, a second PTC device 1004, and a diode 1006 disposed between the PTC devices 1002 and 1004. FIG. 11 illustrates an implementation of the overcurrent protection system of FIG. 10 with the addition of a thermal coupling material 1102. The components and operation of FIGS. 10 and 11 are similar to the components and operation of FIGS. 4 and 5, respectively. One difference is that the implementations of FIGS. 10 and 11 use a single diode 1006 to heat the PTC devices 1002 and 1004 during an overcurrent fault condition, and the implementations of FIGS. 4 and 5 use multiple diodes.

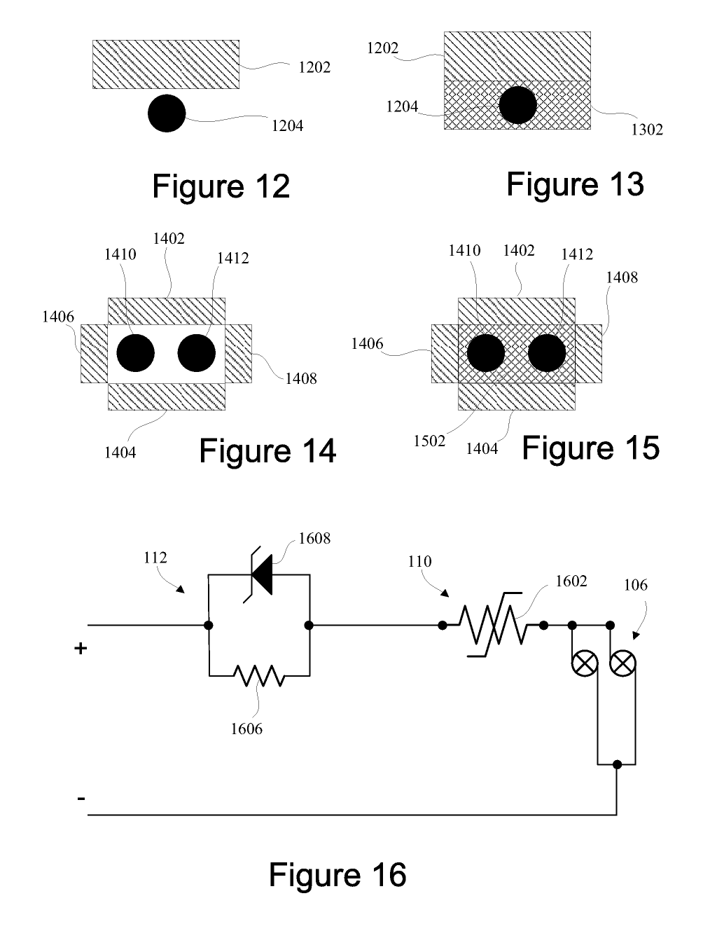

FIG. 12 illustrates an implementation of an overcurrent protection system that includes a single PTC device 1202 and a single diode 1204 positioned adjacent to one side of the PTC device 1202. FIG. 13 illustrates an implementation of the overcurrent protection system of FIG. 12 with the addition of a thermal coupling material 1302, which may be similar to the thermal coupling material 502 described in connection with FIG. 5.

FIG. 14 illustrates an implementation of an overcurrent protection system that includes a plurality of PTC devices 1402, 1404, 1406, and 1408, and one or more diodes 1410 and 1412. The PTC devices 1402, 1404, 1406, and 1408 may be electrically connected in parallel. The PTC devices 1402, 1404, 1406, and 1408 of this implementation may be mechanically arranged around the diodes 1410 and 1412 to form a wall of PTC devices around the diodes 1410 and 1412. FIG. 15 illustrates an implementation of the overcurrent protection system of FIG. 14 with the addition of a thermal coupling material 1502, which may be similar to the thermal coupling material 502 described in connection with FIG. 5.

FIG. 16 is an electrical schematic diagram of another implementation of a current interrupter 110 and an analog circuit 112. The implementation of FIG. 16 is similar to the implementation of FIG. 2. One difference is that the implementation of FIG. 16 is designed for a DC power source. Another difference is that the implementation of FIG. 16 includes a Zener diode 1608 in place of the diodes 208 and 210 of FIG. 2. Alternatively, another type of diode may be used in place of the Zener diode 1608. In FIG. 16, the current interrupter 110 comprises a PTC device 1602. The analog circuit 112 of FIG. 16 comprises a resistor 1606 and the Zener diode 1608.

As shown in FIG. 16, the cathode port of the Zener diode 1608 may be connected with the power source side of the circuit, and the anode port of the Zener diode 1608 may be connected with the side of the circuit that includes the electrical load 106. Therefore, the Zener diode 1608 may operate in a reverse direction in response to a voltage applied across the Zener diode 1608 that is greater than the predetermined breakdown voltage of the Zener diode 1608. The breakdown voltage of the Zener diode 1608 may be 1 volt or higher.

The value of the resistor 1606 may be selected in view of the expected current levels of the application to ensure that the Zener diode 1608 generates little or no heat during a standard operating condition period, but generates a relatively large amount of heat during an overcurrent fault condition. The resistor 1606 may carry more current than the Zener diode 1608 during a first period when a current level through the resistor 1606 is below a predetermined threshold. When the current level through the resistor 1606 is above the predetermined threshold during a second period, the current level passing through the Zener diode 1608 may increase. For example, all of the circuit current or a majority of the circuit current may flow through the resistor 1606 (instead of the Zener diode 1608), until the voltage drop across the resistor 1606 meets or exceeds the breakdown voltage level of the Zener diode 1608. The voltage drop across the resistor 1606 is defined by the resistance of the resistor 1606 and the current level passing through the resistor 1606 according to Ohm's law (V=I×R). The resistance value of the resistor 1606 may be selected to be low enough to keep the Zener diode 1608 in an “off” state in response to the expected current levels during normal operation. The value of the resistor 1606 may also be selected to be high enough to place the Zener diode 1608 in a “breakdown” state in response to the expected current levels during an overcurrent condition.

The overcurrent protection systems shown in FIGS. 1-16 may be used to help protect electrical circuit components from damage or failure due to abnormally high currents. The systems use analog circuit components to thermally control the current interrupt characteristics of a current interrupter device. In some implementations, the systems do not use or require a computer, microcontroller, or processor to detect overcurrent fault conditions. For example, the thermal control sub-circuit (e.g., the analog circuit 112 of FIG. 1) of some implementations may be fully analog. In other implementations, the thermal control sub-circuit may be fully analog and may also use only passive circuit components. In some implementations, the systems do not use or require an integrated circuit and switch combination to detect overcurrent fault conditions.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. An overcurrent protection system, comprising:
a current interrupter electrically coupled between a power source and an electrical load, wherein the current interrupter is configured to interrupt at least a portion of a current flow between the power source and the electrical load based on at least one current interrupt characteristic of the current interrupter; and
an analog circuit component thermally coupled with the current interrupter, wherein the analog circuit component is configured to generate heat in response to an overcurrent fault condition, at least a portion of the heat modifying the at least one current interrupt characteristic of the current interrupter.

2. The system of claim 1, wherein the analog circuit component has a non-linear current-voltage characteristic.

3. The system of claim 1, wherein the current interrupter comprises a polymeric positive temperature coefficient device or a ceramic positive temperature coefficient device.

4. The system of claim 1, wherein the current interrupter comprises a bimetallic breaker.

5. The system of claim 1, wherein the analog circuit component comprises a diode electrically coupled with the current interrupter.

6. The system of claim 1, further comprising a resistor electrically coupled in parallel with the analog circuit component, wherein the resistor is more thermally isolated from the current interrupter than the analog circuit component.

7. The system of claim 6, wherein the resistor is configured to carry more current than the analog circuit component during a first period when a current level through the resistor is below a predetermined threshold.

8. The system of claim 1, further comprising a thermal coupling medium between the analog circuit component and the current interrupter, wherein the thermal coupling medium is configured to transfer at least a portion of the heat from the analog circuit component to the current interrupter.

9. The system of claim 1, further comprising a thermally conducting epoxy that bonds the analog circuit component to the current interrupter.

10. The system of claim 1, wherein the current interrupter comprises a predetermined trip current threshold above which the current interrupter is configured to interrupt at least a portion of the current flow, and wherein at least a portion of the heat from the analog circuit component causes the current interrupter to interrupt at least a portion of the current flow at a current level that is below the predetermined trip current threshold.

11. The system of claim 1, wherein the current interrupter is a first current interrupter, the system further comprising a second current interrupter electrically coupled in parallel with the first current interrupter;
wherein the analog circuit component comprises a heat-emitting surface positioned between the first current interrupter and the second current interrupter.

12. The system of claim 1, wherein the analog circuit component is a first non-linear analog circuit component, the system further comprising a second non-linear analog circuit component electrically coupled in parallel with the first non-linear analog circuit component;
wherein the first non-linear analog circuit component comprises a first heat-emitting surface located adjacent to the current interrupter, and wherein the second non-linear analog circuit component comprises a second heat-emitting surface located adjacent to the current interrupter.

13. The system of claim 1, wherein the analog circuit component comprises a heat-emitting surface that is located 5 millimeters or less from a heat-receiving surface of the current interrupter.

14. An overcurrent protection system, comprising:
a current interrupter electrically coupled between a power source and an electrical load, wherein the current interrupter comprises a predetermined trip current threshold; and
a non-linear analog circuit component electrically and thermally coupled with the current interrupter;
wherein the non-linear analog circuit component is configured to emit heat to the current interrupter in response to an overcurrent fault condition and cause the current interrupter to interrupt at least a portion of a current flow between the power source and the electrical load at a current level that is below the predetermined trip current threshold.

15. The system of claim 14, wherein the non-linear analog circuit component is a first analog circuit component, the system further comprising a second analog circuit component electrically coupled in parallel with the first analog circuit component;
wherein the second analog circuit component is more thermally isolated from the current interrupter than the first analog circuit component; and
wherein the second analog circuit component is configured to carry more current than the first analog circuit component during a first period when a current level through the second analog circuit component is below a predetermined threshold.

16. The system of claim 14, wherein the current interrupter comprises a polymeric positive temperature coefficient device or a ceramic positive temperature coefficient device, and the non-linear analog circuit component comprises a diode.

17. The system of claim 14, wherein the current interrupter is a first current interrupter, the system further comprising a second current interrupter electrically coupled in parallel with the current interrupter;
wherein the non-linear analog circuit component comprises a heat-emitting surface positioned between the first current interrupter and the second current interrupter.

18. The system of claim 14, wherein the non-linear analog circuit component is a first non-linear analog circuit component, the system further comprising a second non-linear analog circuit component electrically coupled in parallel with the first non-linear analog circuit component, wherein a heat-emitting surface of the first non-linear analog circuit component and a heat-emitting surface of the second non-linear analog circuit component are located adjacent to the current interrupter.

19. An overcurrent protection system, comprising:
a polymeric positive temperature coefficient device electrically coupled between a power source and an electrical load, wherein the polymeric positive temperature coefficient device is configured to interrupt at least a portion of a current flow between the power source and the electrical load based on at least one current interrupt characteristic of the polymeric positive temperature coefficient device; and
an analog circuit electrically coupled with the polymeric positive temperature coefficient device, wherein the analog circuit comprises a resistor electrically coupled in parallel with a diode;
wherein the diode is thermally coupled with the polymeric positive temperature coefficient device, wherein the diode is configured to generate heat in response to an overcurrent fault condition, at least a portion of the heat modifying the at least one current interrupt characteristic of the polymeric positive temperature coefficient device.

20. The system of claim 19, wherein the polymeric positive temperature coefficient device comprises a predetermined trip current threshold above which the polymeric positive temperature coefficient device is configured to interrupt at least a portion of the current flow, and wherein at least a portion of the heat from the diode causes the polymeric positive temperature coefficient device to interrupt at least a portion of the current flow at a current level that is below the predetermined trip current threshold.

21. The system of claim 19, wherein the resistor is more thermally isolated from the polymeric positive temperature coefficient device than the diode; and
wherein the resistor is configured to carry more current than the diode during a first period when a current level through the resistor is below a predetermined threshold.
